(19) United States
(12) Patent Application Publication
(10) Pub. No.: US 2006/0144991 A1
(43) Pub. Date: Jul. 6, 2006

(54) Swept-wing box-type aircraft with high fligh static stability

(76) Inventor: Aldo Frediani, Pisa (IT)

Correspondence Address: POLLACK, P.C., THE CHRYSLER BUILDING, 132 EAST 43RD STREET, SUITE 760, NEW YORK, NY, 10017, US

(21) Appl. No.: 10/546,505

(22) PCT Filed: Feb. 19, 2004
(86) PCT No.: PCT/IT04/00071

§ 371 Date: Aug. 19, 2005

(30) Foreign Application Priority Data
Feb. 19, 2003 (IT) FI2003A000043

(51) Int. Cl. B64C 39/12

(52) U.S. Cl. 244/45 R

(57) ABSTRACT

Swept-wing box-type aircraft comprising a fuselage and a lifting system formed by two substantially horizontal wings. One of the wings has a positive sweep angle, while the other has a negative sweep angle, the wings lying in planes spaced apart from one another and joined by two vertical wings extending from their ends. The positively swept wing is the front wing and extends from the bottom of the fuselage, whereas the negatively swept wing is the rear wing and extends generally continuously above the fuselage, the fuselage being provided with a pair of fins at its tail section. The fins are joined at their ends to the rear wing, the fins, the rear wing and the fuselage defining an aerodynamic channel along which the surface of the fuselage is substantially flat.

### FIELD OF THE INVENTION

The present invention relates to a box-plane aircraft with high static stability of flight. More particularly the invention relates to the configuration of such an aircraft.

### BACKGROUND ART

European Patent No. 716978, in the name of the same Applicant, discloses a large dimension aircraft with a lifting system having two horizontal wings, the front one with a positive sweep angle and rear one with a negative sweep angle. The two wings are positioned on two substantially parallel planes and two vertical wings connect the tips of the horizontal wings. The lifting system, as a whole, is therefore of the so-called “box” type in the front view. In the case that the two horizontal wings have the same lift and the lift distribution on the vertical wings is butterfly shaped, the lifting system has the minimum induced drag among all the lifting systems included within the geometrical space delimited by the wings. Considering that, in this type of aircraft, the induced drag decreases for increasing values of the distance between the two horizontal wings for the same wing span, in the aforementioned European patent it was suggested to use this property to design new transport aircraft with a higher efficiency than conventional aircraft. In particular, the application of the concept to very large aircraft (that is, bigger than 400 passengers) was proved to be very advantageous to the end of contain its wing span within prefixed limits to allow the aircraft to operate from actual airports.

The aircraft configuration according to the above mentioned European patent has a fuselage shape which is elongated vertically and subdivided into three decks: a bottom deck for goods and luggage and two upper decks for passengers. The front wing is connected to the bottom fuselage and the rear wing, negatively swept, is connected to top fuselage so that the gap between the horizontal wings is the maximum possible one. The direct connections between wings and fuselage are made in order to avoid aircraft flutter phenomena. As a matter of fact, it was already proposed in the past to connect the rear wing to the top fin, instead of the fuselage, both for box wing (see U.S. Pat. No. 3,834,654) and for diamond shaped wings (see U.S. Pat. No. 4,365,773), but these solutions were dropped due to flutter problems.

Accurate studies conducted out on the aircraft configuration according to European patent 716978, in which both the front and rear wings are connected to the fuselage, revealed that this configuration could be critical as far as the static stability of flight is concerned.

The concept of static stability can be summarized as follows.

A gust encountered by an aircraft flying at constant speed and height produces an effect equivalent to a perturbation of the angle of attack. The aircraft is stable in flight if after being subjected to a gust, the initial flight condition is recovered in a natural way without any control application. In mathematical terms, the aircraft is stable in flight when the derivative of the pitching moment with respect to the angle of attack is negative. In a conventional aircraft, the horizontal tail (or stabilizer) is designed to assure the static stability which depends on the so-called “tail volume”, that is the product of the tail surface, measured in a horizontal plane, and the distance of the aerodynamic centre from the position of the centre of gravity. When a perturbation of the angle of attack (or incidence) of the aircraft occurs, a lift variation on the wing is generated and the same occurs on the tail plane. These lift variations are associated to variations of the pitch moment calculated with respect to the centre of gravity of the aircraft. The moment variation is positive on the wing and negative on the stabilizer. The aircraft is stable when an overall negative variation of the pitch moment results. This condition is met when the position of the resultant of the lift variations is located aft of the centre of gravity position of the aircraft (in this case the moment variation associated to the lift is negative). It is understood how the stabilizer is required to have a sufficiently high tail volume in such a way to move behind the centre of gravity the position of the resultant of the lift variations.

The aircraft according to the European patent no. 716978 has not a stabilizer and the flight stability must be obtained with a proper design of the front and rear wings (wing platforms, airfoils, airfoil twists, etc. ). In particular, the rear wing also performs the function of a stabilizer in a conventional aircraft. In fact, the efficiency of the rear wing at the connection to the fuselage is aerodynamically low due to the shape of the wing and, furthermore, in the case of a transonic aircraft, shock waves at the rear wing belly close to the fuselage easily occur. In these conditions the aircraft stability is possible only when the centre of gravity (coinciding with the centre of the lift forces in stable flight condition) of the aircraft is positioned very close to the front wing in such a way that, anyway, the position of the resultant of the lift variations is aft of the centre of gravity. If the centre of lift forces is displaced forward, the lift load acting on the front wing is much higher than that on the rear wing. Taking into account that, as shown above, the optimum condition occurs when the lift load is the same on both wings, it follows that the condition of static stability of an aircraft such that according to the above mentioned European Patent, results in a reduction of the aerodynamic efficiency.

### OBJECT AND SUMMARY OF THE INVENTION

The object of the present invention is, therefore, to provide a box type aircraft with opposedly swept wings of the type described in the cited European patent but with a configuration which could assure a given static stability of flight without penalizing the efficiency thereof.

The aircraft according to the present invention is provided with a lifting system formed by two horizontal wings, one with a positive sweep angle and the other one with a negative sweep angle, lying on substantially parallel planes, and two vertical wings connecting the ends of the horizontal wings, the front wing being connected to the bottom fuselage. In the aircraft according to the invention the rear wing is no longer connected to the fuselage, but it is positioned above the fuselage to which it is connected by means of two fins and extends with continuity therebetween. In this way, an aerodynamic channel is created in the aft aircraft; the channel is limited by upper fuselage at the bottom side, by the two fins at the sides and by the rear wing at the top side. The air flow established in the channel makes the rear wing very efficient because it is not interrupted by the fuselage as in the case of the European patent n. 716978. In this way, the aerodynamic efficiency of the central region of the rear wing is higher than that at the corresponding root segment of the front wing, which is rooted within the fuselage; this makes it possible to have a static flight stability with a substantially equal distribution of the lift on the two wings.

In the present invention a suitable design of the aerodynamic channel is of the utmost importance to the end of creating the proper configuration of the aerodynamical channel in such a way that the aerodynamic solution described above would be effective. To this end, the greater extend of the fuselage is in the horizontal direction so that the channel can be as large as possible. In this way the fins at the sides of the fuselage can be positioned at the maximum distance from each other. As said before, this makes the aerodynamic channel wide and the overall stiffness of the rear wing is made maximum. In this respect, it must be noted that the constraint between the rear wing and the fuselage has stiffness which increases with the increase of the distance between the fins. In fact the rear wing, from a static point of view, is equivalent to a continuous beam supported by two elastic constraints (the fins), whose flexional stiffness increases with the distance between the two constraints. The same applies to the torsion stiffness and the constraint of the yaw stiffness.

The aircraft configuration according to the present invention can be used for any dimension aircraft, from an ultralight, two-seater aircraft to very large transport aircraft for more than 400 passengers, to mixed passengers freighter aircraft to very large pure freighter, to new configurations of freighter aircraft of the seaplane type.

### BRIEF DESCRIPTION OF THE DRAWINGS

Other features and advantages of the present box-type type aircraft with opposedly swept wings with high static stability will be clearer from the following description of some exemplifying and not limiting embodiments, making reference to the following drawings, wherein:

FIG. 1 shows a schematic perspective view of a very large aircraft according to the invention;

FIG. 2 shows a top plan view of the aircraft of FIG. 1;

FIG. 3 is a front view;

FIG. 4 is a side view;

FIG. 5 is a perspective view of a two-seater ultra-light aircraft according to the present invention;

FIG. 6 is a front view of a very large freighter seaplane aircraft, according to the invention.

### DETAILED DESCRIPTION OF THE INVENTION

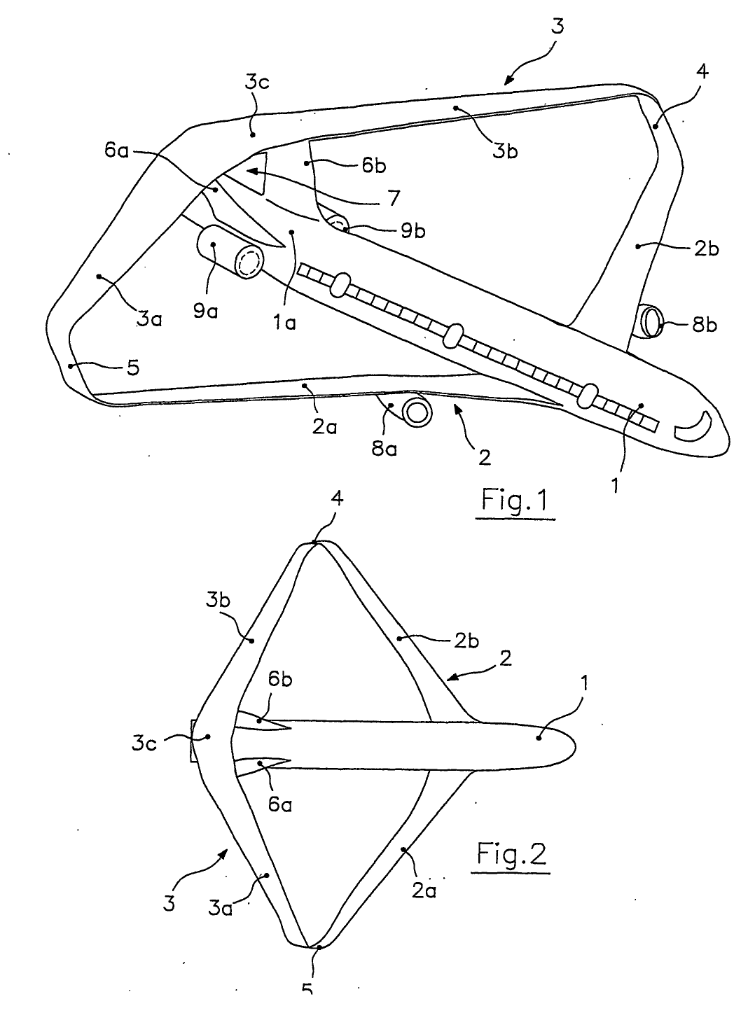

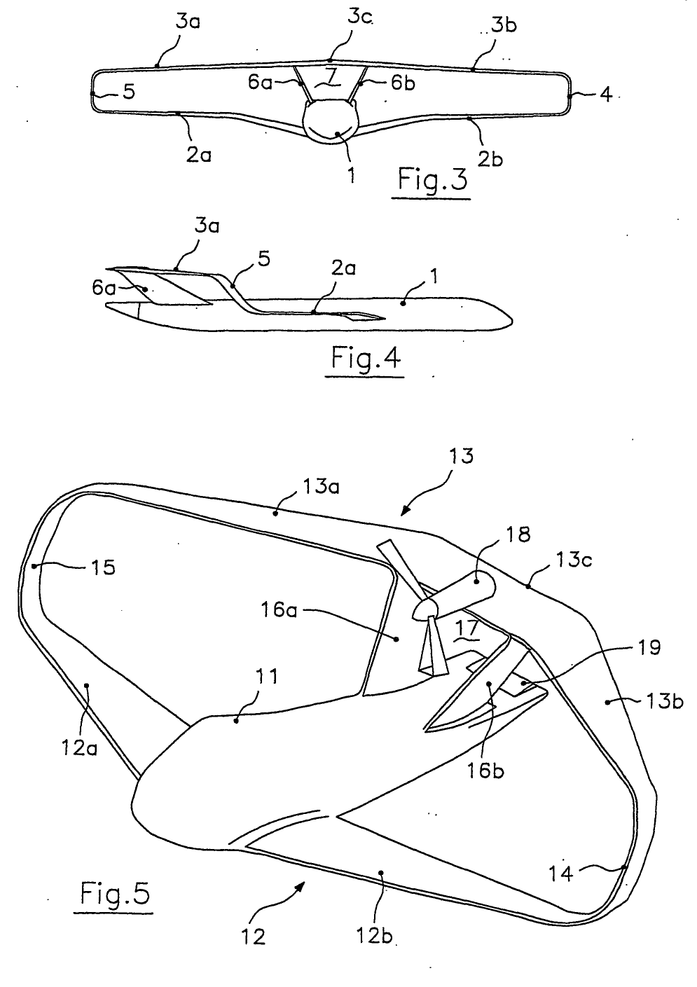

With reference to FIGS. 1 to 4, the aircraft according to the present invention comprises a fuselage 1, a front wing 2 formed by half wings 2a and 2b and a rear wing 3 formed by half wings 3a and 3b, said half-wings 2a, b and 3a, b extending from opposite sides of fuselage 1. The front wing 2 and rear wing 3 have opposite sweep angles; in particular, the sweep angle is positive for front wing 2 and negative for rear wing 3. Besides, the front wing extends from the bottom fuselage 1 and crosses the fuselage under the cargo deck in such a way that the cargo capacity is significantly improved, while rear wing 3 extends over fuselage 1. As a pure example, the sweep angle of half wings 2a and 2b with respect to the longitudinal axis of fuselage 1 is comprised between 30° and 45°, while the angle of half wings 3a and 3b may vary from −18 to −25°.

The average lying planes of front wing 2 and rear wing 3 are close to horizontal and spaced apart from each other and their ends are connected by vertical wings 4 and 5. The front wing has portions inclined upwards (positive dihedral angle) of an angle between 0 and 15° approximately with respect to the horizontal, in order to position the sub-wing engines, while the rear wing, for lateral stability reasons, can present negative downward inclination comprised between 0° and 15° approximately.

A couple of fins 6a and 6b extends from the stern of fuselage 1. The ends of fins 6a, b are connected to rear wing 3, which in turn extends over fuselage 1 continuosly with a bridge portion 3c. The two fins 6a and 6b diverge laterally from the fuselage toward the upside wing 3 and, together with the latter and the fuselage, delimit an aerodynamical channel, generally indicated as 7. The divergence angle between the fins is defined on the basis of reasons of structural optimization.

In the case of civil transport aircraft, fuselage 1 presents a substantially elliptical section with the major axis set horizontally and, in the fuselage stern close to fin roots, the fuselage presents a constant width so as to provide a suitable distance between the fins in order to optimize the efficiency of aerodynamical channel 7 and of the structural stiffness of the connection between rear wing 3 and fuselage 1.

The fuselage flaring in the stern portion takes place in the vertical direction (as seen in side view) and creates a flat edge 1a, in the shape of a trailing edge of an airfoil, between the roots of fins 6a, 6b.

Bridge portion 3c of the rear wing, connected to fuselage 1 by the two fins 6a and 6b so as to make the channel as large as possible, is characterized by a high aerodynamic efficiency, which is bigger than the efficiency of the corresponding portion of the front wing (which contains the crossing of the fuselage); this is valid also in the presence of the downwash effects of the front wing on the rear one.

Engines can be located in a sub-wing position (engines 8a, b) under front wing 2 and in a rear position (engines 9a, b) on fuselage 1 close to fins 6a, b.

In the case of freighter aircraft, the fuselage section could be more squared due to lack of pressurization.

The performances of this aerodynamical configuration have been confirmed by means of numerical computation using Fluent, a CFD (Computational Fluid Dynamics) code. A CFD is a Finite Element code, in which a sufficiently extended volume around the aircraft is modeled with volume elements, which starting from a grid on the aircraft surface, makes discrete elements for the overall volume under control.

From the CFD computations, it resulted that only in the case of a flat or concave configuration of the fuselage surface portion comprised between fins 6a, 6b it is possible to easily obtain equal lifts on two wings and, at the same time, an high degree of stability of flight. In the case in which the upper fuselage is very convex, as in the case of the European patent no. 716978, it resulted that no distribution of airfoil chords, no distribution of twist angles, no kind of airfoil of the rear wing and distance between the upper fuselage and rear wing allows to obtain the static stability of flight together with the same lifts on the two wings.

The static stability of flight, together with the same lifts on the two wings, can be obtained in the presence of a wide set of dimensions of the aerodynamical channel 7 and, in particular, height of the channel, rear wing airfoils, fin airfoils and rate of the fins respect to the vertical direction. These results can not be obtained if the upper fuselage is not flat or concave.

The aircraft configuration according to the invention makes it also possible to trim or control the aircraft in the longitudinal plane, by moving a control surface applied on the trailing edge of the fuselage (not shown in the present embodiment).

In view of its width, the rear portion of the fuselage can allow the presence of more access doors to the cargo bay and, hence, a quicker boarding and disembarkation of goods and luggage is now possible, typical of freighter aircraft. Moreover, the main landing gear fairing is smaller than in the case in which the fuselage is developed in the vertical direction, due to the larger width of the fuselage. Preferably, the main landing gear will be made of more legs with more wheels of smaller diameter with respect to conventional landing gear. In this solution, passengers are located on a single deck, with less windows with respect to the aircraft according to European patent no. 716978, with an advantage as regards the structural weight of the fuselage. Other advantages come from the room saving due to the absence of stairs, less services, less personnel, etc.

The vertical gap between the wings has not limitations, except those coming from structural and aeroelastic problems, and can be changed with a different fin design, said gap not depending on the fuselage dimensions.

The higher aerodynamical efficiency allows one a less fuel consumption and less noise and noxious emissions.

FIG. 5 shows another embodiment of the invention, applied to a small dimension aircraft, as for example, a two-seater aircraft. Even in this case, the aircraft comprises a fuselage 11, a front wing 12 extending from fuselage 11 and formed by half-wings 12a, 12b, substantially horizontal and connected by vertical wings 14 and 15 to a rear wing 13 formed by two half-wings 13a, 13b substantially horizontal. The front wing 12 and the rear wing 13 have opposite sweep angles and, in particular, the sweep angle is positive for the front wing 12 and negative for the rear wing 13. Furthermore, front wing 12 is connected to the bottom/fuselage, while rear wing 13 extends above fuselage 11.

A couple of fins 16a and 16b extends from the stern of fuselage 11. The ends of fins 16a, b are connected to the rear wing 13 and a bridge portion 13c of the rear wing 13 extends continuously over the fuselage. The fins diverge from fuselage 11 toward rear wing 13 to delimit, together with the latter ones, an aerodynamical channel, generally indicated at 17. The rear fuselage presents substantially the same width as the front fuselage, in order to obtain the maximum possible distance between fins 16a and 16b; besides, the rear fuselage is flared in the vertical direction in such a way to be substantially flattened close to the fin roots and the aerodynamic channel delimited by them.

By means of numerical computation, it was shown that, in this case too, no problems occur as regards the static stability of flight and it is possible to obtain a substantially equal distribution of the lift with a high level of static stability.

A propeller can be positioned on the bridge portion 13c of the rear wing and an aerodynamical control surface 19 can be applied at the trailing edge of fuselage 11 for the longitudinal control.

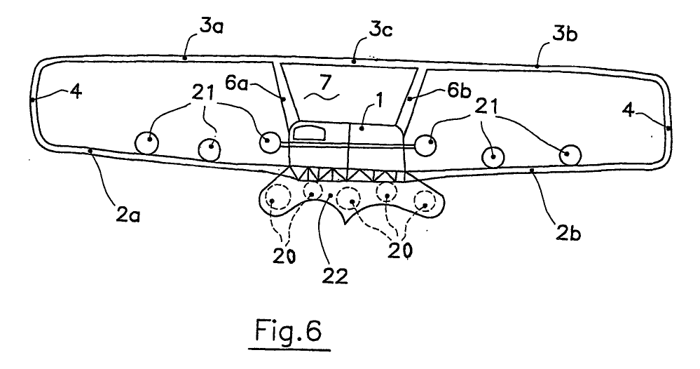

FIG. 6 shows the sketch of a very large dimension freighter aircraft, of the seaplane type, provided with hydrogen or methane engines. The hydrogen/methane gas tanks, indicated at 20, are positioned under the lower deck of the aircraft and located inside float undercarriages 22. Engines 21, in a proper number and power suitable for a full load take off and landing in seafields, are positioned over the wing and at the sides of the fuselage, in this way reducing the external noise level of the aircraft. Due to the absence of noxious emissions of the hydrogen or methane engines, the aircraft can be utilized to fly from internal waters as lakes, rivers or suitable seafields.

Variations and/or modifications can be made to the box-type aircraft with opposedly swept wings with a high static stability according to the present invention, without departing from the scope of the invention as set forth in the appended claims.

What is claimed is:

1. An aircraft which comprises a fuselage and a lifting system formed by two substantially horizontal wings, one wing haing a positive sweep angle, and the other wing haing a negative sweep angle, the wings lying in planes spaced apart from one another and joined by two vertical wings extending from their ends, the positively swept wing being the front wing and extending from the fuselage bottom, and the negatively swept wing being the rear wing and extending generally continuously above the fuselage, wherein the fuselage is provided with a pair of fins at its tail section, the fins being joined at their respective ends to the rear wing, the fins, the rear wing and the fuselage defining an aerodynamic channel along which the surface of the fuselage is substantially flat.

2. The aircraft set forth in claim 1, wherein the fins diverge.

3. The aircraft set forth in claim 1, wherein the fuselage is generally wider in the horizontal direction than in the vertical direction.

4. The aircraft set forth in claim 1, wherein the width of the fuselage in the aero-dynamic channel is substantially equal to its maximum width.

5. The aircraft set forth in claim 1, wherein the fuselage vertically flares correspondingly with its tail section.

6. The aircraft set forth in claim 1, wherein trimming can also be accomplished using a control surface at a rear outlet edge of the fuselage.

7. The aircraft set forth in claim 1, wherein the surface of the fuselage in the aerodynamic channel is substantially concave.

8. A swept-wing box-type aircraft with high static stability of flight comprising a fuselage generally wider in the horizontal direction than in the vertical direction, and a lifting system formed by two substantially horizontal wings, one wing having a positive sweep angle, and the other wing having a negative sweep angle, the wings lying in planes spaced apart from one another and joined by two vertical wings extending from their ends, the positively swept wing being the front wing and extending from the fuselage bottom, and the negatively swept wing being the rear wing and extending relatively continuously above the fuselage, wherein the fuselage is provided with a pair of fins at its tail section, the fins being joined at their respective ends to the rear wing, the fins are diverging, and the fins, the rear wing and the fuselage defining an aerodynamic channel along which the surface of the fuselage is substantially flat, the width of the fuselage in the aerodynamic channel being substantially equal to its maximum width, the fuselage vertically flaring correspondingly with its tail section, and trimming being also accomplished using a control surface at a rear outlet edge of the fuselage.
